(19) United States
(12) Patent Application Publication
(10) Pub. No.: US 2018/0239680 A1
(43) Pub. Date: Aug. 23, 2018

(54) INFORMATION PROCESSING DEVICE AND NON-TRANSITORY COMPUTER READABLE MEDIUM

(71) Applicant: FUJI XEROX CO., LTD., Tokyo (JP)

(72) Inventors: Takayuki HASHIMOTO, Kanagawa (JP); Masaki NUDEJIMA, Kanagawa (JP); Suguru OUE, Kanagawa (JP); Tomoyuki ONO, Kanagawa (JP)

(73) Assignee: FUJI XEROX CO., LTD., Tokyo (JP)

(21) Appl. No.: 15/710,236

(22) Filed: Sep. 20, 2017

(30) Foreign Application Priority Data
Feb. 23, 2017 (JP) 2017-032395

(51) Int. Cl. G06F 11/22; G06F 11/34; G06F 11/36

(52) U.S. Cl. CPC G06F 11/2236; G06F 11/3476; G06F 11/3466; G06F 11/3648; G06F 11/3636

(57) ABSTRACT

An information processing device includes a memory access generating unit and an observation unit. The memory access generating unit generates pseudo memory access by using an arbitration unit in memory access. The observation unit observes a state of the pseudo memory access. The memory access generating unit changes a timing of occurrence of the pseudo memory access along a time axis.

### CROSS-REFERENCE TO RELATED APPLICATIONS

This application is based on and claims priority under 35 USC 119 from Japanese Patent Application No. 2017-032395 filed Feb. 23, 2017.

### BACKGROUND

### Technical Field

The present invention relates to an information processing device and a non-transitory computer readable medium.

### SUMMARY

According to an aspect of the invention, there is provided an information processing device including a memory access generating unit and an observation unit. The memory access generating unit generates pseudo memory access by using an arbitration unit in memory access. The observation unit observes a state of the pseudo memory access. The memory access generating unit changes a timing of occurrence of the pseudo memory access along a time axis.

### BRIEF DESCRIPTION OF THE DRAWINGS

Exemplary embodiment of the present invention will be described in detail based on the following figures, wherein:

FIG. 1 is a conceptual diagram illustrating an exemplary module configuration according to an exemplary embodiment;

FIG. 2 is a conceptual diagram illustrating an exemplary module configuration of a core according to the exemplary embodiment;

FIG. 3 is a diagram for describing the related art;

FIG. 4 is a conceptual diagram illustrating an exemplary module configuration of a direct memory access (DMA) and the like according to the exemplary embodiment;

FIG. 5 is a diagram for describing exemplary image data that is to be subjected to image processing;

FIG. 6 is a diagram for describing an exemplary setting process;

FIG. 7 is a conceptual diagram illustrating an exemplary module configuration of an automatic setting control module and the like according to the exemplary embodiment;

FIG. 8 is a flowchart of an exemplary process according to the exemplary embodiment;

FIG. 9 is a flowchart of an exemplary process according to the exemplary embodiment;

FIG. 10 is a flowchart of an exemplary process according to the exemplary embodiment;

FIG. 11 is a flowchart of an exemplary process according to the exemplary embodiment;

FIG. 12 is a diagram for describing an exemplary configuration of cores and the like that are to be measured, according to the exemplary embodiment; and

FIGS. 13A to 13D are diagrams for describing exemplary logs that are output in the exemplary embodiment.

### DETAILED DESCRIPTION

An exemplary embodiment suitable for implementing the present invention will be described below on the basis of the drawings.

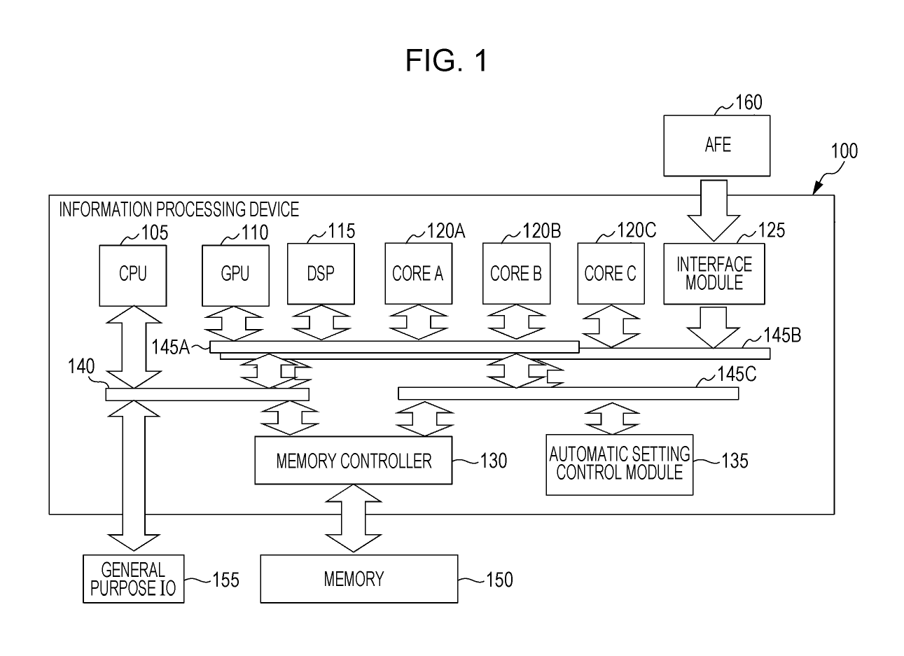

FIG. 1 is a conceptual diagram illustrating an exemplary module configuration according to an exemplary embodiment.

In general, a module refers to a component, such as software (a computer program) that is logically separable or hardware. Thus, a module in the exemplary embodiment refers to not only a module in terms of a computer program but also a module in terms of a hardware configuration. Consequently, the description of the exemplary embodiment also serves as a description of a system, a method, and a computer program which cause the hardware configuration to function as a module (a program that causes a computer to execute procedures, a program that causes a computer to function as units, or a program that causes a computer to implement functions). For convenience of explanation, the terms “to store something” and “to cause something to store something”, and equivalent terms are used. These terms mean that a storage device stores something or that a storage device is controlled so as to store something, when the exemplary embodiment is achieved by using computer programs. One module may correspond to one function. However, in the implementation, one program may constitute one module, or one program may constitute multiple modules. In contrast, multiple programs may constitute a single module. Additionally, multiple modules may be executed by one computer, or one module may be executed by multiple computers in a distributed or parallel processing environment. One module may include another module. Hereinafter, the term “connect” refers to logical connection, such as transmission/reception of data, an instruction, or reference relationship between pieces of data, as well as physical connection. The term “predetermined” refers to a state in which determination has been made before a target process. This term also includes a meaning in which determination has been made in accordance with the situation or state at that time or the situation or state before that time, not only before processes according to the exemplary embodiment start, but also before the target process starts even after the processes according to the exemplary embodiment have started. When multiple “predetermined values” are present, these may be different from one another, or two or more of the values (including all values, of course) may be the same. A description of “when A is satisfied, B is performed” is used as having a meaning of “whether or not A is satisfied is determined and, when it is determined that A is satisfied, B is performed”. However, this term does not include a case where the determination of whether or not A is satisfied is unnecessary.

A system or apparatus refers to one in which multiple computers, pieces of hardware, devices, and the like are connected to one another by using a communication unit such as a network which includes one-to-one communication connection, and also refers to one which is implemented by using a computer, a piece of hardware, a device, or the like. The terms “apparatus” and “system” are used as terms that are equivalent to each other. As a matter of course, the term “system” does not include what is nothing more than a social “mechanism” (social system) operating on man-made agreements.

For each of the processes performed by the respective modules, or for each of the processes in the case where the processes are performed in a single module, target information is read out from a storage device. After the process is performed, the processing result is written in a storage device. Accordingly, description about the reading of data from the storage device before the process and the writing into the storage device after the process may not be made. Examples of the storage device may include a hard disk, a random access memory (RAM), an external storage medium, a storage device via a communication line, and a register in a central processing unit (CPU).

An information processing device 100 according to the exemplary embodiment runs a contention test of memory access in a processor module. As illustrated in the example in FIG. 1, the information processing device 100 includes a CPU 105, a graphics processing unit (GPU) 110, a digital signal processor (DSP) 115, a core A 120A, a core B 120B, a core C 120C, an interface module 125, a memory controller 130, an automatic setting control module 135, a cache coherent interconnect (CCI) 140, an arbiter 145A, an arbiter 145B, and an arbiter 145C. More specifically, the information processing device 100 generates pseudo memory access, and performs automatic setting for the bus arbiters and the like. The information processing device 100 is a large-scale integrated circuit (LSI) whose function and object are specialized in a limited field and application, and is also called an application specific standard product (ASSP) or the like. The arbiters 145A, 145B, and 145C are an exemplary arbitration unit. The arbitration unit has a function of arbitrating, among devices connected to a bus, a privilege for acting as a bus master that activates the bus. A description will be made below by taking arbiters as an example.

In the example in FIG. 1, there are three cores 120. However, any configuration may be employed as long as there are one or more cores. In addition, the GPU 110 and the DSP 115 are not always necessary. However, when there are multiple arbiters 145, the GPU 110, and the DSP 115, a problem of memory access contention easily occurs. Further, the configuration of arbiters 145 is not limited to the configuration illustrated in FIG. 1. As long as there are one or more arbiters 145, any configuration may be employed. As a matter of course, in addition to these configurations, an internal read-only memory (ROM), an internal RAM, a unit for connection with peripherals, and the like may be included.

The CPU 105 is connected to the CCI 140. The CPU 105 performs processing in accordance with programs, and has overall control over the entire information processing device 100. Thus, a memory 150 is accessed.

The GPU 110 is connected to the arbiter 145A. The GPU 110 performs an image display process. Thus, the memory 150 is accessed.

The DSP 115 is connected to the arbiter 145A. The DSP 115 performs digital signal processing. Thus, the memory 150 is accessed.

The cores 120 (the core A 120A, the core B 120B, and the core C 120C) are connected to the arbiter 145A or the arbiter 145B. Each of the cores 120 is a functional block that is individually designed, and is, for example, an application specific integrated circuit (ASIC) or a programmable logic device. For example, the core 120 performs a control process for a certain device. More specifically, the core 120 has a function for performing image processing in a multifunction device (an image processing apparatus having two or more of the functions of a scanner, a printer, a copier, a fax, and the like). As a matter of course, the core 120 may perform a process (for example, speech processing or moving-image processing) in not only a multifunction device but also a home information appliance, a robot, and the like. A description will be made below by taking image processing as an example.

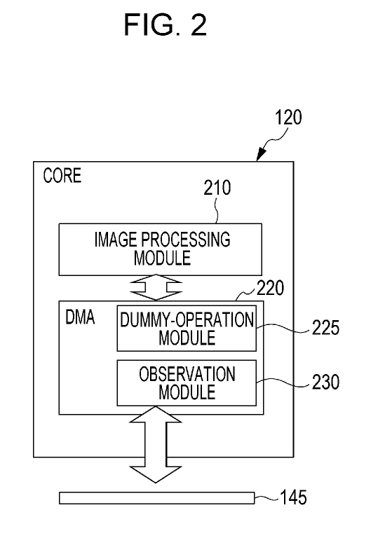

FIG. 2 is a conceptual diagram illustrating an exemplary module configuration of a core 120 according to the exemplary embodiment.

The core 120 has an image processing module 210 and a direct memory access (DMA) 220.

The image processing module 210 is connected to the DMA 220. The image processing module 210 performs image processing. As described above, the image processing module 210 may perform not only image processing but also speech processing, moving-image processing, and the like.

The DMA 220 having a dummy-operation module 225 and an observation module 230 is connected to the image processing module 210 and an arbiter 145. The DMA 220 has a function of transferring data between the image processing module 210 and the memory 150, not through the CPU 105.

The dummy-operation module 225 performs DMA control in order to make memory access equivalent to memory access in an actual image processing operation on the basis of necessary setting values. Examples of image processing include, for example, an enlargement/reduction process, noise reduction, and a compressing process. For example, memory access, such as reading a line multiple times in the enlargement process or skipping reading of a line in the reduction process, occurs.

The dummy-operation module 225 exerts control so that the memory access frequency is changed along the time axis.

The dummy-operation module 225 uses the DMA 220 and the arbiter 145 in memory access to the memory 150 so as to make pseudo memory access. In data transfer between the dummy-operation module 225 and the automatic setting control module 135, for example, access to a register may be used.

The dummy-operation module 225 changes the timing of occurrence of the pseudo memory access along the time axis.

The dummy-operation module 225 may generate pseudo memory access in image processing. The term “pseudo” means that, without operating the image processing module 210, memory access in image processing or the like is made.

The dummy-operation module 225 may generate pseudo memory access by setting the access amount and the access frequency for a scanning line in image processing.

The dummy-operation module 225 may generate pseudo memory access after the automatic setting control module 135 sets the DMA 220 and the arbiter 145.

When the observation module 230 issues a warning or when an observation at a certain occurrence timing is completed, the dummy-operation module 225 may change the occurrence timing.

The observation module 230 observes memory access, and determines whether or not the access is made in a predetermined bandwidth that is to be achieved.

When the observed bandwidth does not reach the bandwidth that is to be achieved, the observation module 230 issues an alert to the automatic setting control module 135.

The observation module 230 observes the state of the pseudo memory access made by the dummy-operation module 225.

When the pseudo memory access is not made in the predetermined bandwidth, the observation module 230 may issue a warning. The expression “predetermined bandwidth” means a target bandwidth (rate). The expression “when the pseudo memory access is not made in the predetermined bandwidth” means a case in which the rate is not achieved in the pseudo memory access.

The observation module 230 outputs the observation result to the automatic setting control module 135.

An analog front end (AFE) 160 is connected to the interface module 125 of the information processing device 100. The AFE 160 is present in a device, such as a scanner or a printer, and plays a role in adjusting an analog signal that is output from the device.

The interface module 125 is connected to the arbiter 145B and the AFE 160. The interface module 125 communicates with the AFE 160 that is an external device, receives data from the device, and transmits an instruction and the like to the device. Thus, the memory 150 is accessed.

The memory 150 is connected to the memory controller 130 of the information processing device 100. The memory 150 may be accessed by the information processing device 100, and is called a main memory, a shared memory, or the like. The memory 150 is accessed from the multiple cores 120, the GPU 110, the DSP 115, and the like. The stored data is image data that is to be subjected to image processing, processing result data, and the like. In addition to these, programs, parameters, and the like are stored.

The memory controller 130 is connected to the CCI 140, the arbiter 145C, and the memory 150. The memory controller 130 is a control device that performs reading/writing in a specified area in the memory 150. The area is specified by using memory addresses. The memory controller 130 receives reading/writing requests from the CCI 140 and the arbiters 145. That is, memory access is transferred through the arbiters 145 to the memory controller 130.

The automatic setting control module 135 is connected to the arbiter 145C. The automatic setting control module 135 sets the DMAs 220 in the cores 120 and the arbiters 145. The automatic setting control module 135 may set only the arbiters 145.

The automatic setting control module 135 may set priority order for the arbiters 145, and may set memory addresses for the DMAs 220.

The automatic setting control module 135 may set the dummy-operation modules 225 and the arbiters 145 again when the observation module 230 issues a warning.

The automatic setting control module 135 may present recommended setting values by using observation results received from the observation module 230.

Specifically, the automatic setting control module 135 sets the DMAs 220 and the arbiters 145 on the basis of information on the memory, and exerts control so that the DMAs 220 are activated and reset.

When the observation module 230 determines that the bandwidth is not achieved, the automatic setting control module 135 exerts control so that the DMAs 220 are reset, the arbiters 145 are set again, and the DMAs 220 are restarted.

The automatic setting control module 135 stores, in the memory 150, log data for setting control of the arbiters 145, and presents recommended setting values on the basis of the setting control results.

The CCI 140 is connected to the CPU 105, the arbiter 145A, the arbiter 145B, the memory controller 130, and a general purpose IO 155. The CCI 140 is called a cache coherent interconnect (CCI) bus, and functions as a device (arbitration device) that arbitrates requests among the CPU 105, the memory controller 130, the general purpose IO 155, the GPU 110, and the like. The CCI 140 is a bus that transmits, on the basis of a request from the CPU 105 or the like, a request for reading/writing to the memory controller 130 with specification of an area in the memory 150. The CCI 140 operates so that the consistency (coherency) between data stored in the memory 150 and data that is read into a cache memory of the CPU 105 from the memory 150 is maintained.

The arbiter 145A is connected to the GPU 110, the DSP 115, the core A 120A, the core B 120B, the CCI 140, and the arbiter 145C.

The arbiter 145B is connected to the core C 120C, the interface module 125, the CCI 140, and the arbiter 145C.

The arbiter 145C is connected to the memory controller 130, the automatic setting control module 135, the arbiter 145A, and the arbiter 145B.

An arbiter 145 that is called an arbiter or a bus arbiter arbitrates a privilege to act as a bus master that drives a bus, among devices (the cores 120 and the like) connected to the bus, in accordance with a rule defined with certain priority order. When two or more devices, each of which may act as a bus master, are connected to a bus, an arbiter 145 is necessary.

The general purpose IO 155 is connected to the CCI 140 of the information processing device 100. The general purpose IO 155 is, for example, a communication unit conforming to a standard, such as Universal Serial Bus (USB) or Ethernet®, and communicates with external devices. Thus, the memory 150 is accessed.

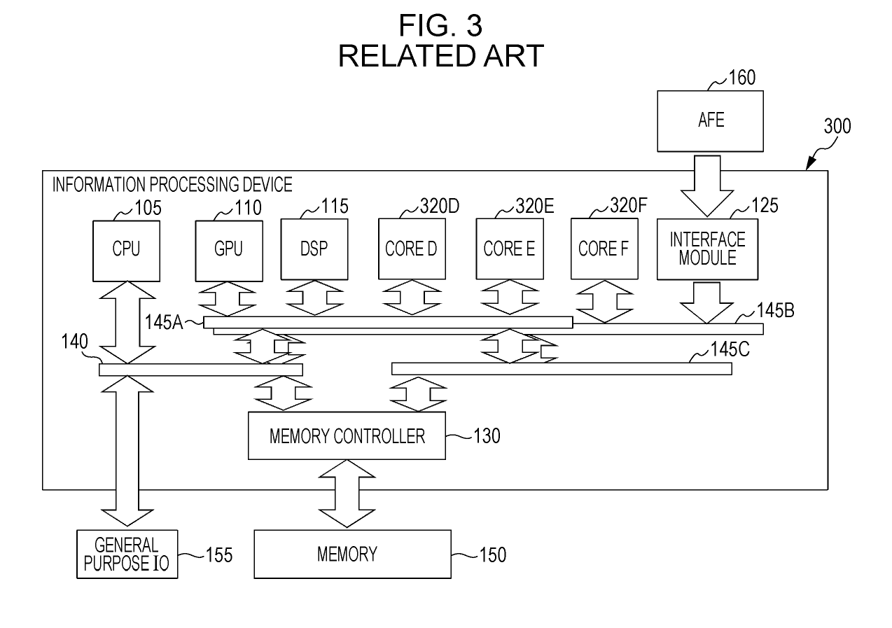

FIG. 3 is a diagram for describing the related art. An information processing device 300 includes the CPU 105, the GPU 110, the DSP 115, a core D 320D, a core E 320E, a core F 320F, the interface module 125, the memory controller 130, the CCI 140, the arbiter 145A, the arbiter 145B, and the arbiter 145C. That is, when the exemplary embodiment illustrated in the example in FIGS. 1 and 2 is compared with the information processing device 300 of the related art which is illustrated in the example in FIG. 3, the information processing device 100 is a device in which the automatic setting control module 135 is added to the information processing device 300 and in which the dummy-operation module 225 and the observation module 230 are added in the DMA 220 of a core 120. The functions of the units are equivalent to those illustrated in the example in FIG. 1.

When the information processing device 300 is to perform, for example, performance evaluation of image processing, it is necessary to operate all of the cores 320 supporting respective modes. Examples of the modes include scanning, printing, and faxing. As setting of an arbiter, “setting of priority for the arbiter 145A” is performed in the arbiter 145A. For example, “the first priority for the core E 320E and the second priority for the DSP 115”, or the like is set. In the arbiter 145B, “setting of priority for the arbiter 145B” is performed. For example, “the first priority for the core F 320F and the second priority for the core D 320D” or the like is set.

When the bandwidth is not achieved with default arbiter settings, it is necessary to reset the arbiters 145 and perform evaluation again. However, many settings need to be made in order to operate the cores 320, and evaluation is not performed until implementation of software for the entire information processing device 300 is completed.

In addition, the cores 320 are designed by the respective designers (companies). Therefore, the internal configuration, the detailed specification, and the like are not always on public view (that is, each of the cores 320 needs to be treated as a black box in many cases). In the first place, it is difficult to perform bandwidth evaluation. Therefore, it is necessary to generate actual memory access and run a contention test.

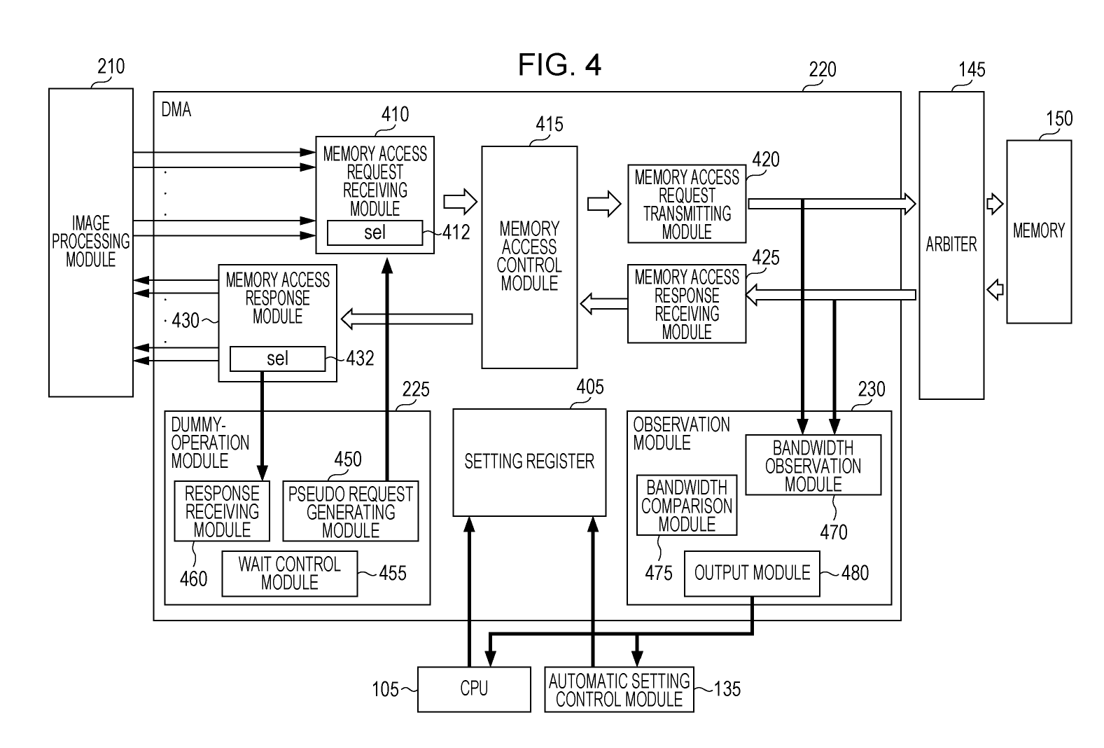

FIG. 4 is a conceptual diagram illustrating an exemplary module configuration of a DMA 220 and the like according to the exemplary embodiment.

The DMA 220 includes a setting register 405, a memory access request receiving module (buffer) 410, a memory access control module 415, a memory access request transmitting module 420, a memory access response receiving module 425, a memory access response module 430, the dummy-operation module 225, and the observation module 230.

The image processing module 210 is connected to the memory access request receiving module (buffer) 410 and the memory access response module 430 of the DMA 220. The image processing module 210 accesses the memory 150 through the DMA 220 and an arbiter 145 for image processing. When pseudo memory access from the dummy-operation module 225 occurs, the image processing module 210 does not operate.

The CPU 105 is connected to the setting register 405 of the DMA 220 and an output module 480 in the observation module 230.

The automatic setting control module 135 is connected to the setting register 405 of the DMA 220 and the output module 480 in the observation module 230.

The setting register 405 is connected to the CPU 105 and the automatic setting control module 135. The setting register 405 is accessed from the CPU 105 or the automatic setting control module 135, and causes the DMA 220 to make pseudo memory access.

The memory access request receiving module (buffer) 410 having a sel 412 is connected to the image processing module 210, the memory access control module 415, and a pseudo request generating module 450 in the dummy-operation module 225. The memory access request receiving module (buffer) 410 typically performs a process for making memory access to the arbiter 145 in accordance with an instruction from the image processing module 210. When the sel 412 receives an instruction to make pseudo memory access from the pseudo request generating module 450 in the dummy-operation module 225, the memory access request receiving module (buffer) 410 regards the instruction to make pseudo memory access as being equivalent to an instruction from the image processing module 210 to make memory access, and makes memory access to the arbiter 145.

The sel 412 in the memory access request receiving module (buffer) 410 is connected to the pseudo request generating module 450 in the dummy-operation module 225. The sel 412 receives an instruction to make pseudo memory access from the pseudo request generating module 450.

The memory access control module 415 is connected to the memory access request receiving module (buffer) 410, the memory access request transmitting module 420, the memory access response receiving module 425, and the memory access response module 430. Upon reception of an instruction to make memory access (including pseudo memory access) from the memory access request receiving module (buffer) 410, the memory access control module 415 transmits an instruction to the memory access request transmitting module 420. Upon reception of a result of the memory access from the memory access response receiving module 425, the memory access control module 415 transmits the result to the memory access response module 430.

The memory access request transmitting module 420 is connected to the memory access control module 415, a bandwidth observation module 470 in the observation module 230, and the arbiter 145. Upon reception of an instruction from the memory access control module 415 to make memory access, the memory access request transmitting module 420 accesses the memory 150 through the arbiter 145.

The arbiter 145 is connected to the memory access request transmitting module 420 and the memory access response receiving module 425 in the DMA 220, and is also connected to the bandwidth observation module 470 in the observation module 230 and the memory 150.

The memory 150 is connected to the arbiter 145.

The memory access response receiving module 425 is connected to the memory access control module 415 and the arbiter 145. Upon reception of a result of memory access from the memory 150 through the arbiter 145, the memory access response receiving module 425 transmits the result to the memory access control module 415.

The memory access response module 430 is connected to the image processing module 210, the memory access control module 415, and a response receiving module 460 in the dummy-operation module 225. When the memory access response module 430 receives a result of memory access from the memory access control module 415, if the result corresponds to an instruction from the image processing module 210 to make memory access, the memory access response module 430 transmits the result to the image processing module 210. If the result corresponds to an instruction to make pseudo memory access, the memory access response module 430 transmits the result to the response receiving module 460 in the dummy-operation module 225 through a sel 432.

The sel 432 in the memory access response module 430 is connected to the response receiving module 460 in the dummy-operation module 225. The sel 432 receives a result of pseudo memory access, and transmits the result to the response receiving module 460 of the dummy-operation module 225.

The dummy-operation module 225 includes the pseudo request generating module 450, a wait control module 455, and the response receiving module 460.

The pseudo request generating module 450 in the dummy-operation module 225 is connected to the sel 412 of the memory access request receiving module (buffer) 410. The pseudo request generating module 450 transmits an instruction to make pseudo memory access to the sel 412 of the memory access request receiving module (buffer) 410. An instruction to make pseudo memory access is a signal equivalent to an access signal from the image processing module 210.

The wait control module 455 in the dummy-operation module 225 controls a frequency at which requests are generated, in accordance with settings. The wait control module 455 dynamically switches, with time, the frequency at which requests are generated.

The response receiving module 460 in the dummy-operation module 225 is connected to the sel 432 in the memory access response module 430. The response receiving module 460 receives a result corresponding to an instruction from the pseudo request generating module 450 to make pseudo memory access. The response receiving module 460 is not necessarily provided, and the memory access response module 430 may process the received result.

The observation module 230 includes the bandwidth observation module 470, a bandwidth comparison module 475, and the output module 480.

The bandwidth observation module 470 in the observation module 230 is connected to a bus between the memory access request transmitting module 420 and the arbiter 145 and a bus between the memory access response receiving module 425 and the arbiter 145. The bandwidth observation module 470 observes the bandwidth or the like between the memory access request transmitting module 420 and the arbiter 145 and the bandwidth or the like between the memory access response receiving module 425 and the arbiter 145.

The bandwidth comparison module 475 in the observation module 230 determines whether or not the bandwidth or the like between the memory access request transmitting module 420 and the arbiter 145 which is observed by the bandwidth observation module 470 reaches the target bandwidth.

The output module 480 in the observation module 230 is connected to the CPU 105 and the automatic setting control module 135. The output module 480 outputs an observation result from the bandwidth observation module 470 and a determination result from the bandwidth comparison module 475 to the CPU 105 or the automatic setting control module 135.

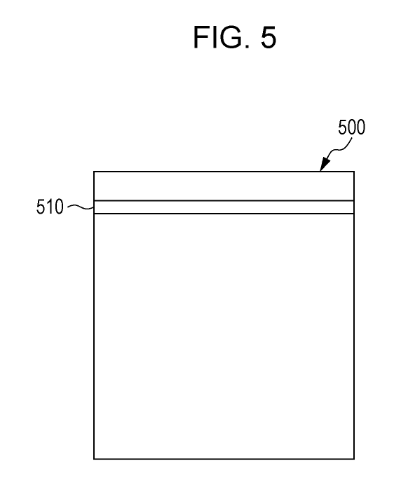

FIG. 5 is a diagram for describing exemplary image data that is to be subjected to image processing.

An image 500 is data that is to be processed by the image processing module 210, and is two-dimensional data. The image 500 is constituted by multiple lines 510 in the main scanning direction. Image processing is typically performed on a line 510.

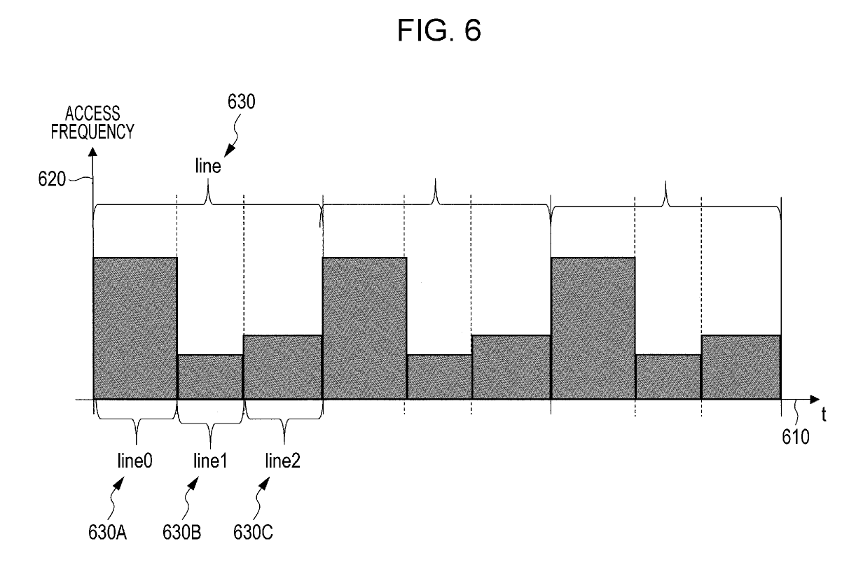

FIG. 6 is a diagram for describing an exemplary setting process performed by the wait control module 455. The wait control module 455 causes the pseudo request generating module 450 to access the memory 150 in consideration of the access frequency, change in the access frequency with time, and the like.

In image processing, a frequency of memory access is changed with time (in accordance with the number of accesses) in accordance with the resolution of a target image and information about which type of process is to be performed on the target image. For example, each line 510 is processed, or each block is processed.

Specifically, the wait control module 455 controls a wait time required until the next memory access, on the basis of setting values.

An example in FIG. 6 is illustrated as follows. For example, a line 630 is divided into three sections of a line 0 630A, a line 1 630B, and a line 2 630C. The horizontal axis represents t axis 610, and the vertical axis represents access frequency 620. As illustrated in the example in FIG. 6, the pseudo request generating module 450 is controlled so that memory access is repeatedly made in the three sections in the single line 630 at respective access frequencies (at a high frequency in the line 0 630A, at a low frequency in the line 1 630B, and at a middle frequency in the line 2 630C). That is, the access frequency and change in the access frequency with time are controlled. For example, the number of lines, the access amount of each line section, and the access frequency of each line section are controlled by using a variable line_num (the number of lines to be subjected to bandwidth evaluation), a variable line_byte (the access amount (Σlinei_byte) for one line), a variable line0_byte (the access amount in line section 0), a variable line0_wait_cycle (the access frequency in line section 0), a variable line1_byte (the access amount in line section 1), a variable line1_wait_cycle (the access frequency in line section 1), . . . , a variable linen_byte (the access amount in line section n), and a variable linen_wait_cyle (the access frequency in line section n). As a matter of course, instead of dividing a line into three sections, the entire line (without dividing a line into sections) may be used. Alternatively, a line may be divided into two sections, or a line may be divided into four or more sections. The number of sections may be different depending on a line, or a different access frequency may be assigned to each line.

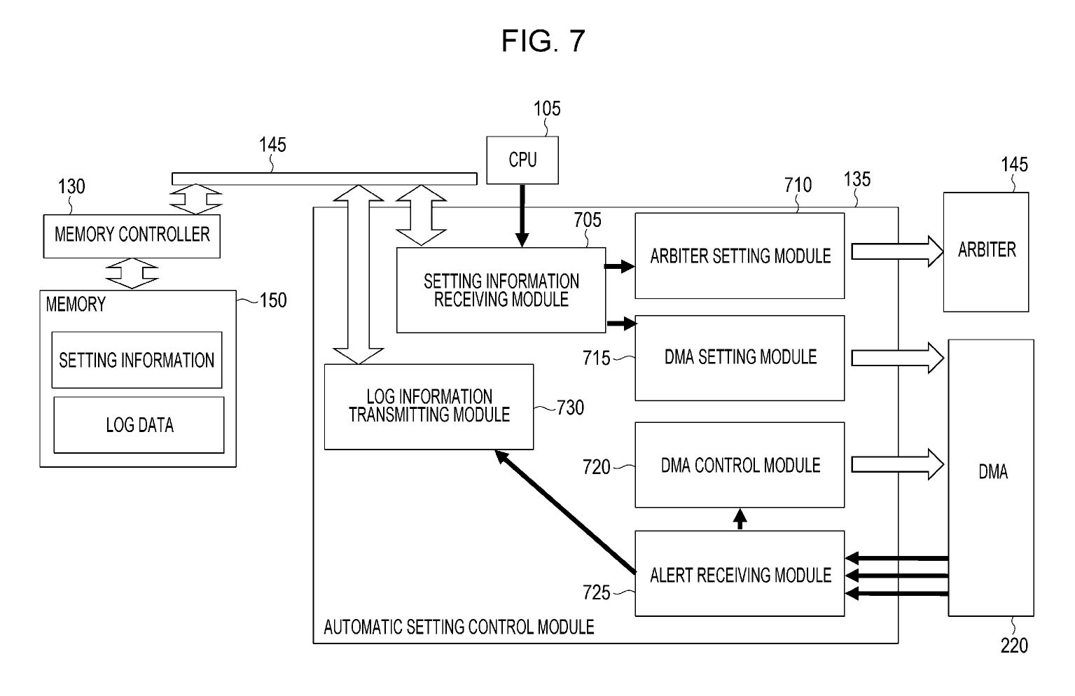

FIG. 7 is a conceptual diagram of an exemplary module configuration of the automatic setting control module 135 and the like according to the exemplary embodiment.

The automatic setting control module 135 includes a setting information receiving module 705, an arbiter setting module 710, a DMA setting module 715, a DMA control module 720, an alert receiving module 725, and a log information transmitting module 730.

The setting information receiving module 705 is connected to the arbiter setting module 710, the DMA setting module 715, the CPU 105, and the arbiters 145. The setting information receiving module 705 sets priority of the cores 120 and the like for the arbiters 145 in accordance with an instruction from the CPU 105 (or setting information in the memory 150). The setting information receiving module 705 also sets, for the DMA 220, memory addresses (area) that are to be accessed. Specifically, the setting information receiving module 705 has a function of interface with a setting register of the DMA or the like.

The CPU 105 is connected to the setting information receiving module 705 of the automatic setting control module 135.

The arbiter setting module 710 is connected to the setting information receiving module 705 and the arbiters 145. The arbiter setting module 710 sets priority of the cores 120 for the arbiters 145 in accordance with an instruction from the setting information receiving module 705.

The arbiters 145 are connected to the setting information receiving module 705, the arbiter setting module 710, and the log information transmitting module 730 of the automatic setting control module 135. The arbiters 145 control memory access of the cores 120 and the like in accordance with settings made by the arbiter setting module 710. Specifically, when memory access contention occurs, memory access permission is given to a core 120 or the like that is performing memory access and that has high priority.

The DMA setting module 715 is connected to the setting information receiving module 705 and the DMAs 220. The DMA setting module 715 sets memory addresses for access for the DMAs 220 in accordance with an instruction from the setting information receiving module 705.

The alert receiving module 725 is connected to the DMA control module 720, the log information transmitting module 730, and the DMAs 220. The alert receiving module 725 receives outputs from the DMAs 220 or the output modules 480. Upon reception of an alert (warning), the alert receiving module 725 submits an instruction for resetting or restarting to the DMA control module 720.

The DMA control module 720 is connected to the alert receiving module 725 and the DMAs 220. The DMA control module 720 resets or restarts the DMAs 220 in accordance with an instruction from the alert receiving module 725.

The DMAs 220 are connected to the DMA setting module 715, the DMA control module 720, and the alert receiving module 725 of the automatic setting control module 135. The DMAs 220 make memory access in accordance with settings made by the DMA setting module 715, and are reset or restarted by the DMA control module 720.

The log information transmitting module 730 is connected to the alert receiving module 725 and the arbiters 145. The log information transmitting module 730 stores log data (including an alert and the like, and log data and the like from the output modules 480 in the observation modules 230) from the alert receiving module 725 in the memory 150 through the arbiters 145 and the memory controller 130.

The memory 150 stores setting information of the arbiters 145 and setting information of the DMAs 220, and stores log data from the log information transmitting module 730. The log data includes, for example, observation values, setting information with which testing has been performed.

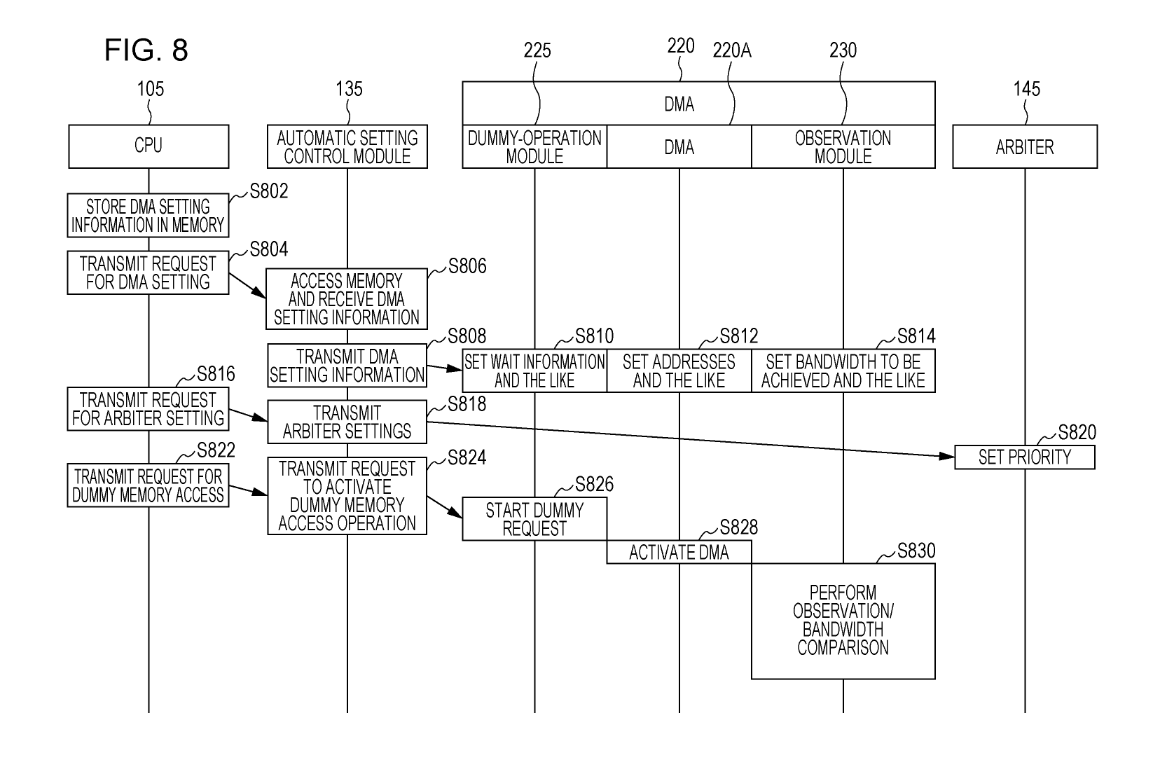

FIG. 8 is a flowchart of an exemplary process according to the exemplary embodiment. FIG. 8 illustrates an exemplary process performed among the CPU 105, the automatic setting control module 135, a DMA 220 (the dummy-operation module 225, a DMA 220A, and the observation module 230), and an arbiter 145. As a matter of course, the CPU 105 performs processing in accordance with programs for testing of memory access contention.

In step S802, the CPU 105 stores DMA setting information in the memory 150.

In step S804, the CPU 105 requests the automatic setting control module 135 to perform DMA setting.

In step S806, the automatic setting control module 135 (setting information receiving module 705) accesses the memory 150, and receives DMA setting information.

In step S808, the automatic setting control module 135 transmits the DMA setting information to the dummy-operation module 225.

In step S810, the dummy-operation module 225 sets wait information and the like. Specifically, the wait information is the setting information described by using the example in FIG. 6.

In step S812, the DMA 220A sets addresses and the like. Specifically, the DMA 220A specifies addresses for memory access.

In step S814, the observation module 230 sets a bandwidth to be achieved and the like. Specifically, the bandwidth is a target bandwidth. When the bandwidth is not achieved, a warning is issued.

In step S816, the CPU 105 requests the automatic setting control module 135 to perform arbiter setting.

In step S818, the automatic setting control module 135 transmits arbiter settings to the arbiter 145.

In step S820, the arbiter 145 sets priority in accordance with the arbiter settings.

In step S822, the CPU 105 requests the automatic setting control module 135 to make dummy memory access.

In step S824, the automatic setting control module 135 requests the dummy-operation module 225 to activate a dummy memory access operation.

In step S826, the dummy-operation module 225 receives the dummy request, and starts a dummy memory access operation.

In step S828, the DMA 220A activates DMA and performs a dummy memory access operation.

In step S830, the observation module 230 observes the dummy memory access, and compares the actual bandwidth with the target bandwidth.

The processes from step S810 to step S814, the process in step S820, and the processes from step S826 to step S830 are repeatedly performed while settings are changed in accordance with the programs for testing of memory access contention.

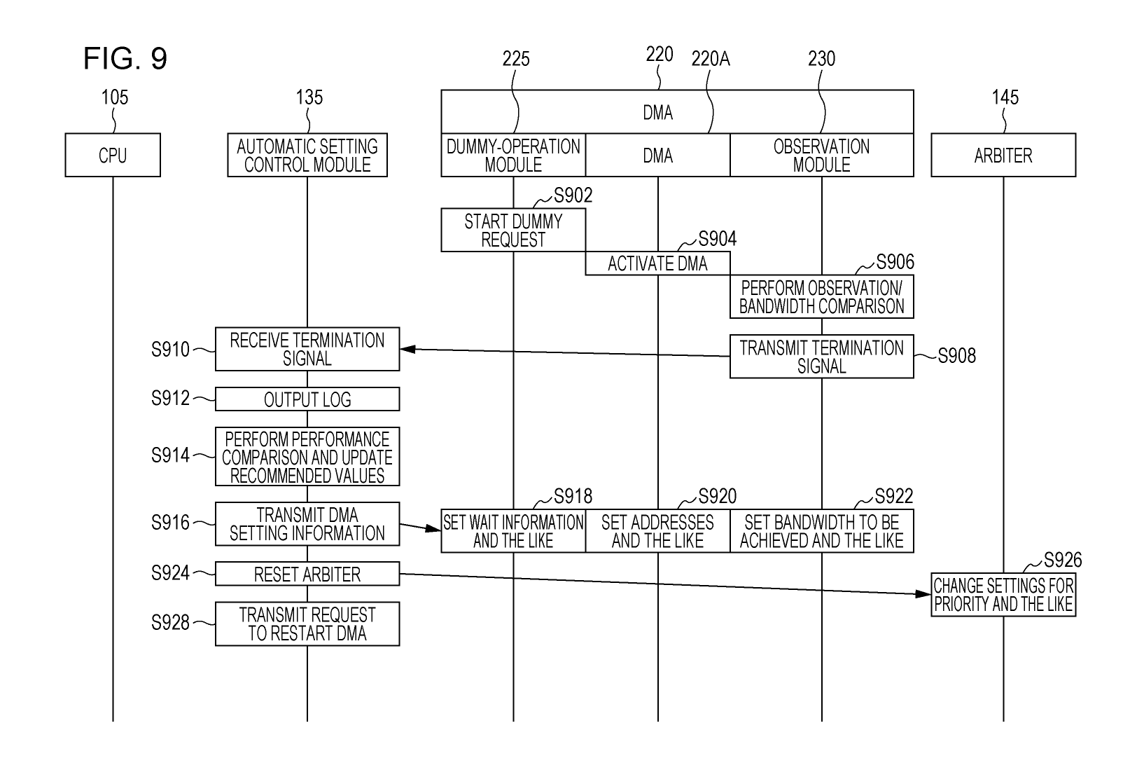

FIG. 9 is a flowchart of an exemplary process according to the exemplary embodiment. FIG. 9 illustrates an example of normal end without an alert. The process in FIG. 9 is performed after the process illustrated in the example in FIG. 8. The processes from step S902 to step S906 are equivalent to the processes from step S826 to step S830.

In step S902, the dummy-operation module 225 receives the dummy request and starts the dummy memory access operation.

In step S904, the DMA 220A activates DMA and performs the dummy memory access operation.

In step S906, the observation module 230 observes the dummy memory access and compares the actual bandwidth with the target bandwidth.

In step S908, the observation module 230 transmits a termination signal to the automatic setting control module 135.

In step S910, the automatic setting control module 135 receives the termination signal from the observation module 230.

In step S912, the automatic setting control module 135 outputs a log.

In step S914, the automatic setting control module 135 performs performance comparison and updates recommended values.

The processes until this step indicate processes from the first setting operation to a dummy memory access process, log output, performance comparison, and updating of recommended values. The processes in step S916 and its subsequent steps are processes for the second loop.

In step S916, the automatic setting control module 135 transmits DMA setting information to the dummy-operation module 225.

In step S918, the dummy-operation module 225 sets wait information and the like.

In step S920, the DMA 220A sets addresses and the like.

In step S922, the observation module 230 sets a bandwidth to be achieved and the like.

In step S924, the automatic setting control module 135 resets the arbiter.

In step S926, the arbiter 145 changes settings for priority and the like.

The processes from step S916 to step S926 are equivalent to the processes from step S808 to step S814 and the processes in steps S818 and S820 which are illustrated in the example in FIG. 8.

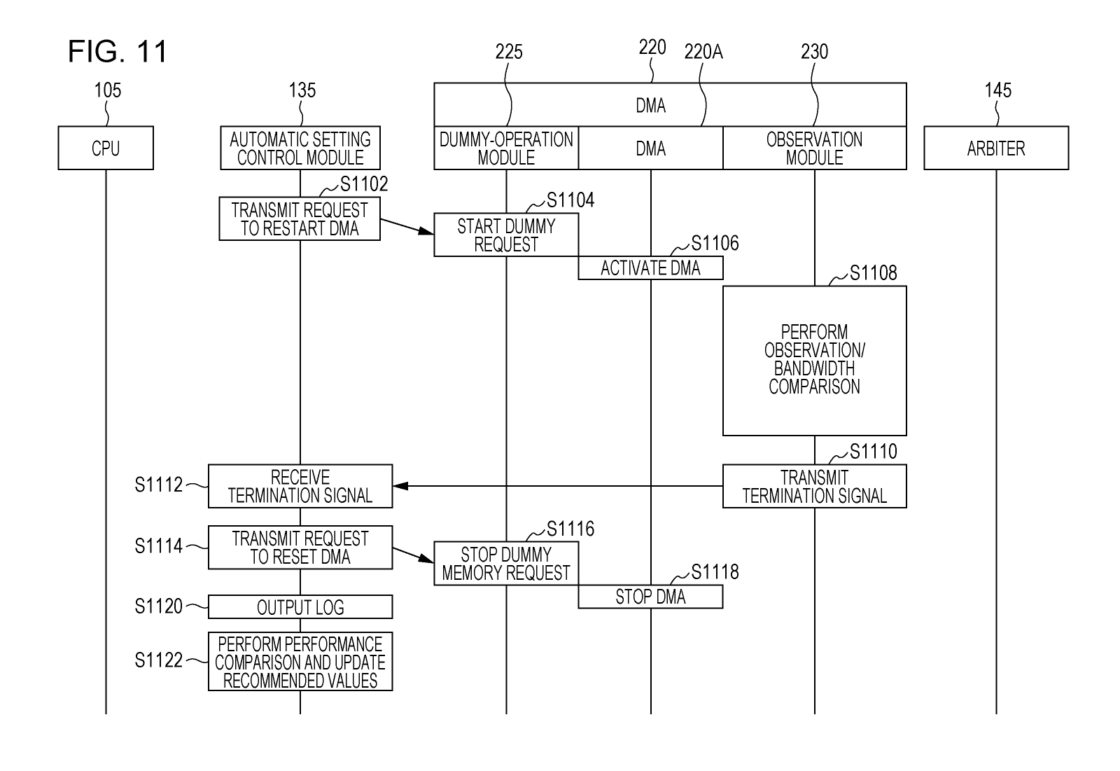

In step S928, the automatic setting control module 135 requests the dummy-operation module 225 to restart DMA. After that, the process continues to the process illustrated in the example in FIG. 11.

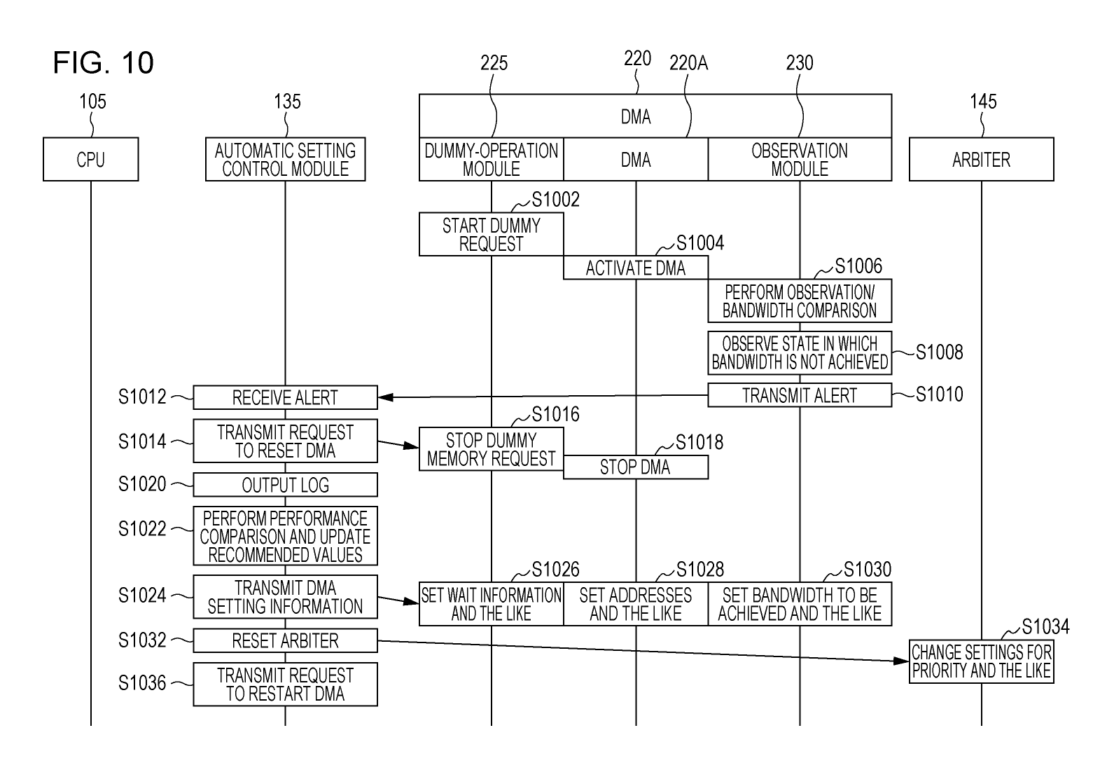

FIG. 10 is a flowchart of an exemplary process according to the exemplary embodiment. FIG. 10 illustrates an example in which an alert is issued. The process in FIG. 10 is performed after the process illustrated in the example in FIG. 8. The processes from step S1002 to step S1006 are equivalent to the processes from step S826 to step S830.

In step S1002, the dummy-operation module 225 receives the dummy request and starts the dummy memory access operation.

In step S1004, the DMA 220A activates DMA and performs the dummy memory access operation.

In step S1006, the observation module 230 observes the dummy memory access and compares the actual bandwidth with the target bandwidth.

In step S1008, the observation module 230 observes a state in which the bandwidth is not achieved. That is, the observed bandwidth does not reach the target bandwidth.

In step S1010, the observation module 230 transmits an alert to the automatic setting control module 135.

In step S1012, the automatic setting control module 135 receives the alert from the observation module 230.

In step S1014, the automatic setting control module 135 requests the dummy-operation module 225 to reset DMA.

In step S1016, the dummy-operation module 225 stops the dummy memory request.

In step S1018, the DMA 220A stops DMA.

In step S1020, the automatic setting control module 135 outputs a log.

In step S1022, the automatic setting control module 135 performs performance comparison and updates recommended values.

The processes until this step indicate processes from the first setting operation to a dummy memory access process, log output, performance comparison, and updating of recommended values. The processes in step S1024 and its subsequent steps indicate processes performed the second time.

In step S1024, the automatic setting control module 135 transmits DMA setting information to the dummy-operation module 225.

In step S1026, the dummy-operation module 225 sets wait information and the like.

In step S1028, the DMA 220A sets addresses and the like. In step S1030, the observation module 230 sets a bandwidth to be achieved and the like.

In step S1032, the automatic setting control module 135 resets the arbiter.

In step S1034, the arbiter 145 changes settings for priority and the like.

The processes from step S1024 to step S1034 are equivalent to the processes from step S808 to step S814, and the processes in steps S818 and S820 which are illustrated in the example in FIG. 8.

In step S1036, the automatic setting control module 135 requests the dummy-operation module 225 to activate DMA again. After that, the process continues to the process illustrated in the example in FIG. 11.

FIG. 11 is a flowchart of an exemplary process according to the exemplary embodiment. FIG. 11 illustrates processes performed after the process illustrated in the example in FIG. 9 or 10.

In step S1102, the automatic setting control module 135 requests the dummy-operation module 225 to activate DMA again. The process in this step is equivalent to the process in step S928 or step S1036.

In step S1104, the dummy-operation module 225 receives the dummy request and starts a dummy memory access operation.

In step S1106, the DMA 220A activates DMA and performs a dummy memory access operation.

In step S1108, the observation module 230 observes the dummy memory access and compares the actual bandwidth with the target bandwidth.

In step S1110, the observation module 230 transmits a termination signal to the automatic setting control module 135.

In step S1112, the automatic setting control module 135 receives the termination signal from the observation module 230.

The processes from step S1104 to step S1112 are equivalent to the processes from step S902 to step S910.

In step S1114, the automatic setting control module 135 requests the dummy-operation module 225 to reset DMA.

In step S1116, the dummy-operation module 225 stops the dummy request.

In step S1118, the DMA 220A stops DMA.

In step S1120, the automatic setting control module 135 outputs a log.

In step S1122, the automatic setting control module 135 performs performance comparison and updates recommended values.

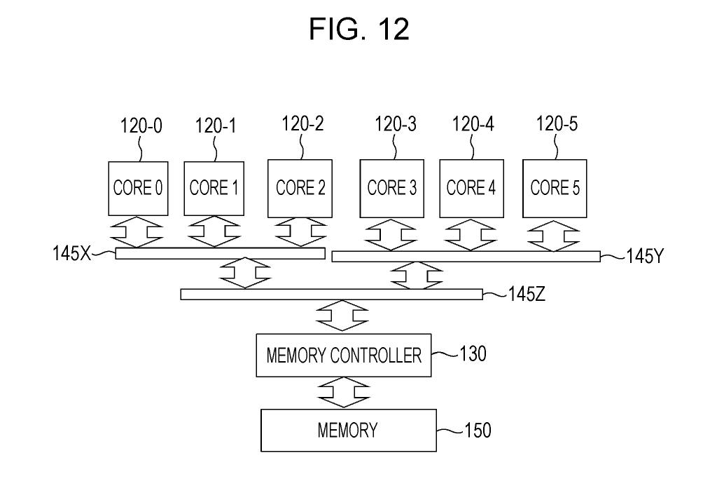

FIG. 12 is a diagram for describing an exemplary configuration of cores and the like that are to be measured, according to the exemplary embodiment. This example illustrates an exemplary processor module in which there are six cores 120 that are divided into two groups each having three cores 120, and in which the arbiters 145 have a hierarchical structure. That is, a core 0 120-0 is connected to an arbiter 0_0 145X. A core 1 120-1 is connected to the arbiter 0_0 145X. A core 2 120-2 is connected to the arbiter 0_0 145X. A core 3 120-3 is connected to an arbiter 0_1 145Y. A core 4 120-4 is connected to the arbiter 0_1 145Y. A core 5 120-5 is connected to the arbiter 0_1 145Y.

The arbiter 0_0 145X is connected to the core 0 120-0, the core 1 120-1, the core 2 120-2, and an arbiter 1_0 1452. The arbiter 0_1 145Y is connected to the core 3 120-3, the core 4 120-4, the core 5 120-5, and the arbiter 1_0 1452. The arbiter 1_0 1452 is connected to the arbiter 0_0 145X, the arbiter 0_1 145Y, and the memory controller 130. That is, the arbiters 145 of the first stage (the arbiter 0_0 145X and the arbiter 0_1 145Y) arbitrate access from the respective three-core sets (a set of the core 0 120-0, the core 1 120-1, and the core 2 120-2, and a set of the core 3 120-3, the core 4 120-4, and the core 5 120-5). The arbiter 1_0 145Z of the second stage arbitrates access from the two arbiters 145 of the first stage.

The memory controller 130 is connected to the arbiter 1_0 145Z and the memory 150.

The memory 150 is connected to the memory controller 130.

Each of the cores 120 has a configuration as illustrated in the example in FIG. 2, in which the dummy-operation module 225, the observation module 230, and the automatic setting control module 135 run a memory access contention test.

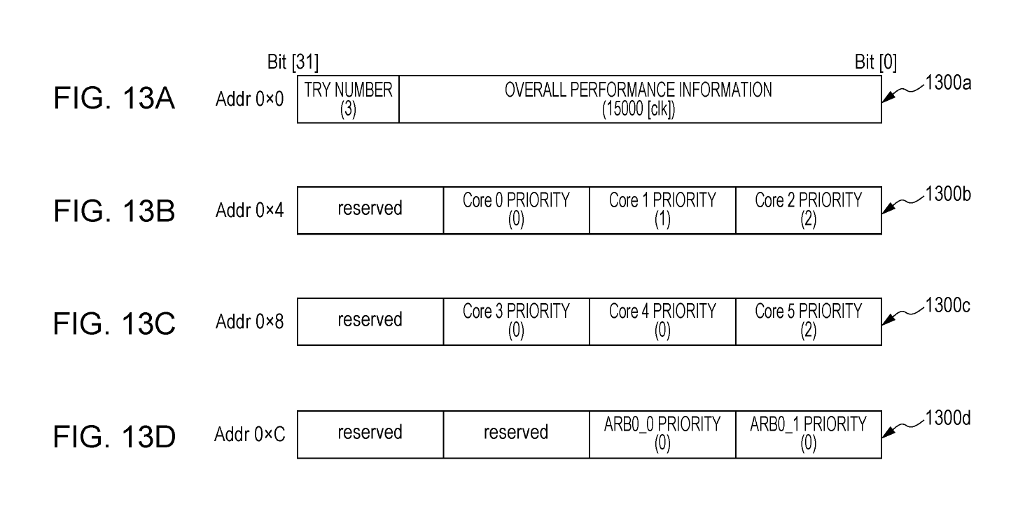

FIG. 13 is a diagram for describing exemplary log data that is output in the exemplary embodiment. That is, FIG. 13 illustrates exemplary log data and the like obtained in the case of the configuration illustrated in the example in FIG. 12. Specifically, FIG. 13 illustrates log data of arbiter setting control and output of recommended values.

The following log information is output to a memory and a register.
The overall performance information (a time until completion of all of the access, observation values, and the like)
Setting values and the like that are set for the arbiters and that indicate the order of priority of a master that makes access

Log data 1300a illustrated in the example in FIG. 13A has a try number (for example, (3)) and the overall performance information (for example, (15000 [clk])). That is, the log data 1300a stores a time required until all of the dummy access is completed. Specifically, the log data 1300a stores the number of clocks or the like which are required until completion. In the example in FIG. 13A, the result indicates that the third test has taken 15000 clk.

Log data 1300b illustrated in the example in FIG. 13B indicates priority setting information used in the arbiter 0_0 145X, and has information of “reserved”, the priority of the core 0 120-0 (for example (0)), the priority of the core 1 120-1 (for example, (1)), and the priority of the core 2 120-2 (for example, (2)).

Log data 1300c illustrated in the example in FIG. 13C indicates priority setting information used in the arbiter 0_1 145Y, and has information of “reserved”, the priority of the core 3 120-3 (for example, (0)), the priority of the core 4 120-4 (for example, (0)), and the priority of the core 5 120-5 (for example, (2)).

Log data 1300d illustrated in the example in FIG. 13D indicates priority setting information used in the arbiter 1_0 145Z, and has information of “reserved”, “reserved”, the priority of the arbiter 0_0 145X (for example, (0)), and the priority of the arbiter 0_1 145Y (for example, (0)).

That is, priority settings for the arbiters (the arbiter 0_0 145X, the arbiter 0_1 145Y, and the arbiter 1_0 1452) are stored. In the examples illustrated in FIGS. 13B to 13D, the lower the value of a number is, the higher the priority is. The same value indicates priority of the same level. In the example in FIG. 13B, the order of priority of the memory access processes in the arbiter 0_0 145X is the order of the core 0 120-0, the core 1 120-1, and the core 2 120-2.

When memory access contention occurs, whether or not the image processing satisfies target performance is evaluated. When the image processing does not satisfy the target performance, settings for the arbiters need to be changed.

Priority settings (the log data 1300b, the log data 1300c, and the log data 1300d) for the arbiters which correspond to log data (log data 1300a) whose overall performance information indicates the best value and which is obtained with normal end without occurrence of an alert may be presented as recommended setting values.

The automatic setting control module 135 may automatically set the arbiters 145 multiple times. For example, all of the combinations of priorities of the cores 120 and the like may be sequentially set, and a memory access contention test may be run.

After contention tests with a predetermined number of combinations are run, the automatic setting control module 135 may generate combinations of priorities which are similar to the combinations of priorities that are obtained with normal end and that are among the combinations, and contention tests may be run.

In contrast, after contention tests with a predetermined number of combinations are run, the automatic setting control module 135 may exclude combinations of priorities that are similar to combinations of priorities obtained with occurrence of a warning and that are among the combinations, and contention tests may be run.

The programs described above may be provided through a recording medium storing the programs, or may be provided through a communication unit. In these cases, for example, the programs described above may be interpreted as an invention of “a computer-readable recording medium that stores a program”.

The term “a computer-readable recording medium that stores a program” refers to a computer-readable recording medium that stores programs and that is used for, for example, installation and execution of the programs and distribution of the programs.

Examples of the recording medium include a digital versatile disk (DVD) having a format of “DVD-recordable (DVD-R), DVD-rewritable (DVD-RW), DVD-random access memory (DVD-RAM), or the like” which is a standard developed by the DVD forum or having a format of “DVD+recordable (DVD+R), DVD+rewritable (DVD+RW), or the like” which is a standard developed by the DVD+RW alliance, a compact disk (CD) having a format of CD read only memory (CD-ROM), CD recordable (CD-R), CD rewritable (CD-RW), or the like, a Blu-ray® Disk, a magneto-optical disk (MO), a flexible disk (FD), a magnetic tape, a hard disk, a ROM, an electrically erasable programmable ROM (EEPROM®), a flash memory, a RAM, and a secure digital (SD) memory card.

For example, all of the above-described programs or some of them may be stored and distributed by recording them on the recording medium. In addition, the programs may be transmitted through communication, for example, by using a transmission medium of, for example, a wired network or a wireless communication network which is used for a local area network (LAN), a metropolitan area network (MAN), a wide area network (WAN), the Internet, an intranet, an extranet, and the like, or a combination of these. Instead, the programs may be carried on carrier waves.

The above-described programs may be all or some of other programs, or may be recorded on a recording medium along with other programs. Instead, the programs may be recorded on multiple recording media by dividing the programs. The programs may be recorded in any format, such as compression or encryption, as long as it is possible to restore the programs.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
a memory access generating unit that generates pseudo memory access by using an arbitration unit in memory access; and
an observation unit that observes a state of the pseudo memory access,
wherein the memory access generating unit changes a timing of occurrence of the pseudo memory access along a time axis.

2. The information processing device according to claim 1,
wherein the memory access generating unit generates the pseudo memory access in image processing.

3. The information processing device according to claim 2,
wherein the pseudo memory access is generated by setting an access amount and an access frequency for a scanning line in the image processing.

4. The information processing device according to claim 1, further comprising:
a setting unit that sets the arbitration unit,
wherein, after the setting unit sets the arbitration unit, the memory access generating unit generates the pseudo memory access.

5. The information processing device according to claim 4,
wherein the setting unit sets priority order for the arbitration unit.

6. The information processing device according to claim 1,
wherein, when the pseudo memory access is not made in a predetermined bandwidth, the observation unit issues a warning.

7. The information processing device according to claim 6,
wherein, when the observation unit issues the warning, the arbitration unit is reset.

8. The information processing device according to claim 6,
wherein, when the observation unit issues the warning or when observation at a certain timing of the occurrence is ended, the memory access generating unit changes the timing of the occurrence.

9. The information processing device according to claim 4, further comprising:
a presentation unit that presents a recommended setting value by using an observation result which is output from the observation unit.

10. A non-transitory computer readable medium storing a program causing a computer to execute a process comprising:
generating pseudo memory access by using an arbitration unit in memory access; and
observing a state of the pseudo memory access,
wherein, in the generating of pseudo memory access, a timing of occurrence of the pseudo memory access is changed along a time axis.
